(19) United States
(12) Patent Application Publication
(10) Pub. No.: US 2010/0297412 A1
(43) Pub. Date: Nov. 25, 2010

(54) PLASTIC COMPONENT WITH DIAMOND-LIKE CARBON LAYER

(75) Inventor: Ga-Lane Chen, Santa Clara, CA (US)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/612,051

(22) Filed: Nov. 4, 2009

(30) Foreign Application Priority Data
May 20, 2009 (CN) 200910302445.4

(51) Int. Cl. B32B 7/02; B32B 5/00

(52) U.S. Cl. 428/213; 428/336

(57) ABSTRACT

An exemplary plastic component includes a polymer base, a metallic luster layer formed on the polymer base, and a diamond-like carbon layer formed on the metallic luster layer. The metallic luster layer is comprised of a material selected from the group consisting of silicon nitride, silicon carbide, titanium carbide, and a combination thereof. A thickness of the metallic luster layer is in the range from 50 nm to 1000 nm. The diamond-like carbon layer has a thickness in the range from 5 nanometers to 50 nanometers.

### BACKGROUND

1. Technical Field

The present disclosure relates to a plastic component, and particularly to a plastic component for use as a shell of an electronic device.

2. Description of Related Art

With the development of wireless communication technology and information processing technology, portable electronic devices, such as mobile telephones and notebooks, are now in widespread use. These electronic devices enable consumers to enjoy the convenience of high technology services, almost anytime and at virtually any location.

Generally, an electronic device includes a shell and a number of components received and cooperated in the shell. The exterior surface of the shell is normally made of light weight plastics. However, plastic products usually do not do the justice of attracting consumers. In addition, plastic products have a poor corrosion resistance.

What is needed, therefore, is to provide a plastic component which can overcome the aforementioned problems.

### BRIEF DESCRIPTION OF THE DRAWINGS

Many aspects of the present plastic component can be better understood with reference to the following drawings. The components in the drawings are not necessarily drawn to scale, the emphasis instead being placed upon clearly illustrating the principles of the present lens module. Moreover, in the drawings, all the views are schematic, and like reference numerals designate corresponding parts throughout the several views.

FIG. 1 is a cross-sectional schematic view of part of a plastic component in accordance with a first embodiment;

FIG. 2 is a cross-sectional schematic view of part of a plastic component in accordance with a second embodiment;

FIG. 3 is a cross-sectional schematic view of part of a plastic component in accordance with a third embodiment.

FIG. 4 is a cross-sectional schematic view of part of a plastic component in accordance with a fourth embodiment.

### DETAILED DESCRIPTION

Reference will now be made to the drawings to describe in detail the referred embodiments of the plastic component.

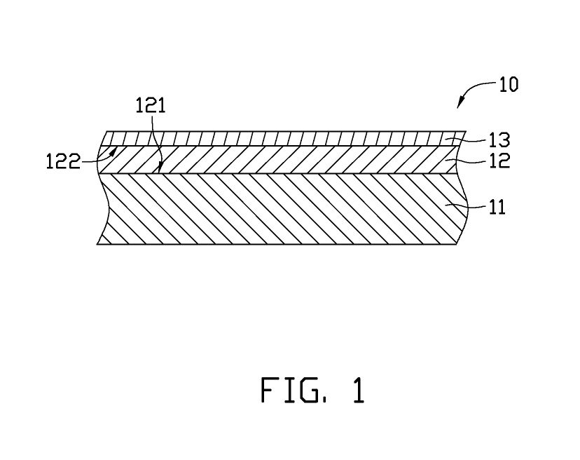

Referring to FIG. 1, a plastic component 10 includes a polymer base 11, a metallic luster layer 12, and a diamond-like carbon (DLC) layer 13. The polymer base 11 is comprised of a polymer suitable to be used as a shell of an electronic device. The polymer can be selected from the group consisting of polycarbonate (PC), polypropylene (PP), poly (acrylonitrile, butadiene, styrene) (ABS), poly (methyl methacrylate) (PMMA), and any combination thereof. It is understood that the configuration and dimension of the polymer base 11 may vary depending on the particular electronic device.

The metallic luster layer 12 has a luster like metal, capable of shining like metal by reflecting lights. The metallic luster layer 12 is interposed between and is in contact with both of the polymer base 11 and the DLC layer 13. In other words, the metallic luster layer 12 has a first surface 121 in intimate contact with the polymer base 11 and a second surface 122 in intimate contact with the DLC layer 13, with the second surface 122 being in an opposite side of the metallic luster layer 12 to the first surface 121. A material of the metallic luster layer 12 is selected from the group consisting of silicon nitride (Si₃N₄), silicon carbide (SiC), titanium carbide (TiC), and a combination thereof. For example, the metallic luster layer 12 can be a Si₃N₄ layer, a SiC layer, or a TiC layer. The thickness of the metallic luster layer 12 is in the range from 50 nanometers (nm) to 1000 nm.

The DLC layer 13 performs as a protective layer. The DLC layer 13 is transparent, and has good corrosion resistance. The DLC layer 13 can be one of a hydrogenated amorphous DLC film and a nitrogenated amorphous DLC film. A thickness of the DLC layer 13 is in the range from 5 nm to 50 nm. Because the thickness of the DLC layer 13 is equal to or less than 50 nm, phases of the DLC layer 13 in microstructure are discontinuous, thus that the DLC layer 13 is dielectric. In other words, the DLC layer 13 with such a thickness is insulated and cannot conduct electricity.

Due to the transparence of the DLC layer 13, the luster of the metallic luster layer 12 can be represented at the exterior surface of the plastic component 10. Therefore, when the plastic component 10 is used as a shell of an electronic device, the electronic device can have a beautiful sheen like metal. In addition, due to the insulativity of both of the metallic luster layer 12 and the DLC layer 13, when the electronic device is capable of wireless communication, the metallic luster layer 12 and the DLC layer 13 would not effect the transmission of the wireless signals.

It is understood that the polymer base 11 can be formed via a molding process, the metallic luster layer 12 and the DLC layer 13 can be formed by magnetron sputtering technology.

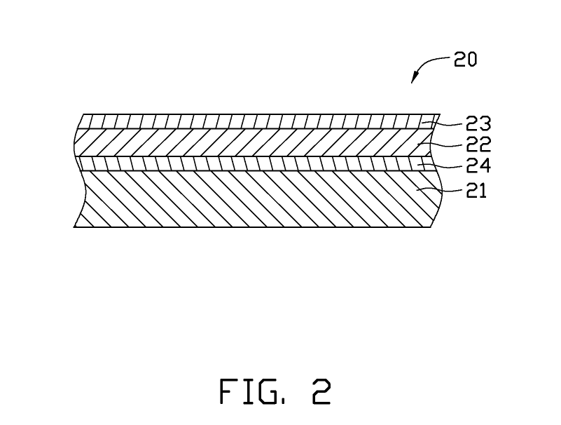

Referring to FIG. 2, a second embodiment of the plastic component 20 includes a polymer base 21, an intermediate layer 24, a metallic luster layer 22, and a DLC layer 23 formed in sequence. A material of the polymer base 21 can be selected from the group consisting of PC, PP, ABS, PMMA, and a combination thereof.

The intermediate layer 24 is interposed between and in contact with both of the polymer base 21 and the metallic luster layer 22. The intermediate layer 24 is comprised of chromium nitride (CrN), chromium carbide (CrC), or chromium dioxide (CrO₂). In particular, the intermediate layer 24 can consist essentially of CrN, CrC, or CrO₂. A thickness of the intermediate layer 24 is in the range from 2 nm to 10 nm. Due to such a thickness of the intermediate layer 24, the phases of the intermediate layer 24 in microstructure are discontinuous, thus that the intermediate layer 24 is dielectric. It is understood that the intermediate layer 24 also can be formed by sputtering technology.

The metallic luster layer 22 is interposed between and is in contact with both of the intermediate layer 24 and the DLC layer 23. The metallic luster layer 22 is comprised of Si₃N₄, SiC, TiC, or a combination thereof. In particular, the metallic luster layer 22 can consist essentially of one of Si₃N₄, SiC, and TiC. The thickness of the metallic luster layer 22 is in the range from 50 nm to 1000 nm.

The DLC layer 23 is in contact with the DLC layer 23 and is away from the polymer base 21. The DLC layer 13 can be one of a hydrogenated amorphous DLC film and a nitrogenated amorphous DLC film, and has a thickness in the range from 5 nm to 50 nm.

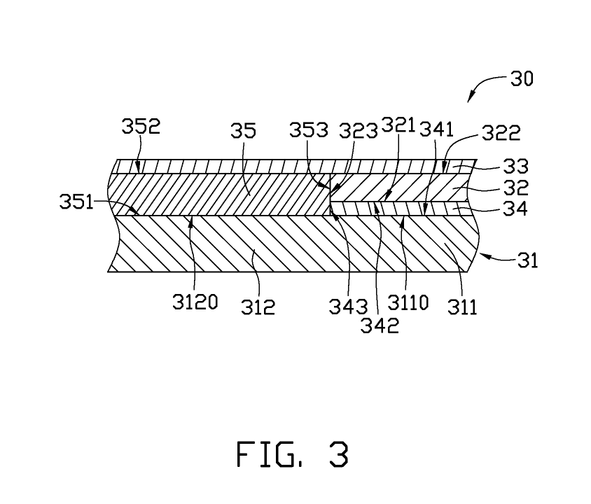

Referring to FIG. 3, a third embodiment of the plastic component 30 includes a polymer base 31, an intermediate layer 34, an electrically conductive layer 35, a metallic luster layer 32, and a DLC layer 33. The polymer base 31 has a first portion 311 and a second portion 312 proximate to the first portion 311. The first portion 311 has a first outer surface 3110. The second portion 312 has a second outer surface 3120, which is coplanar with the first outer surface 3110. The intermediate layer 34 is formed on the first outer surface 3110 of the first portion 311. The metallic luster layer 32 is formed on the intermediate layer 34. The electrically conductive layer 35 is formed on the second outer surface 3120 of the second portion 312, and comprises of chromium, aluminum, or any other suitable electrically conductive material. In particular, the electrically conductive layer 35 can be chromium layer or aluminum layer. A thickness of the electrically conductive layer 35 is equal to a sum of thicknesses of the intermediate layer 34 and the metallic luster layer 32. The DLC layer 33 is evenly arranged on the electrically conductive layer 35 and the metallic luster layer 32.

In detail, the intermediate layer 34 has a first bottom surface 341 in contact with the first outer surface 3110 of the first portion 311, a first top surface 342 at an opposite side of the intermediate layer 34 to the first bottom surface 341, and a first side surface 343 interconnecting the first bottom and first top surfaces 341, 342. The metallic luster layer 32 has a second bottom surface 321 in contact with the first top surface 342, a second top surface 322 at an opposite side of the metallic luster layer 32 to the second bottom surface 321, and a second side surface 323 interconnecting the second bottom and second top surfaces 321, 322. The second side surface 323 is coplanar with the first side surface 343. The electrically conductive layer 35 has a third bottom surface 351 in contact with the second outer surface 3120 of the second portion 312, a third top surface 352 at an opposite side of the electrically conductive layer 35 to the third bottom surface 351, and a third side surface 353 interconnecting the third bottom and top surfaces 351, 352. The third top surface 352 is coplanar with the second top surface 322. The third side surface 353 is in intimate contact with the first and second side surfaces 323, 343. The DLC layer 33 is in intimate contact with the second and third top surfaces 322, 352.

In the illustrated embodiment, the plastic component 30 has an electromagnetic shielding portion corresponding to the first portion 311 and an electromagnetic passing portion corresponding to the second portion 312. Therefore, when the plastic component 30 is used as a shell of an electronic device, which is capable of wireless communication, the transmission of the wireless signals of the electronic device would not be effected due to the electromagnetic passing portion, and any other magnetic interference would be shielded by the electromagnetic shielding portion. In addition, the electronic device has a beautiful appearance with a sheen like metal, and has strong anticorrosion property.

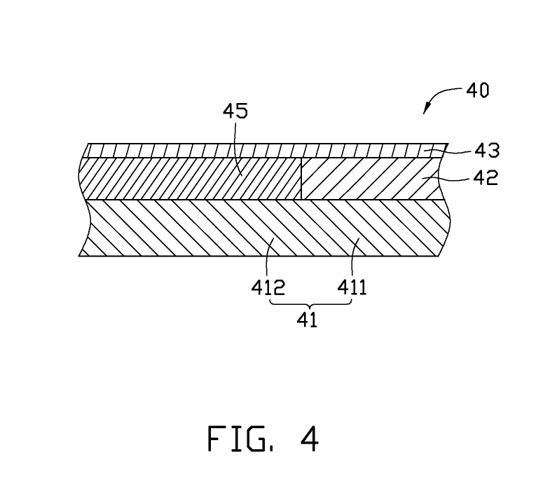

Referring to FIG. 4, a fourth embodiment of the plastic component 40 includes a polymer base 41, an electrically conductive layer 45, a metallic luster layer 42, and a DLC layer 43. The polymer base 41 includes a first portion 411 and a second portion 412 proximate to the first portion 411. The metallic luster layer 42 is arranged between and in contact with the first portion 411 and the DLC layer 43. The electrically conductive layer 45 is arranged between and in contact with the second portion 412 and the DLC layer 43. The metallic luster layer 42 has a thickness equal to that of the electrically conductive layer 45.

The polymer base 41, the electrically conductive layer 45, the metallic luster layer 42, and the DLC layer 43 have material and structure similar to that of the polymer base 31, the electrically conductive layer 35, the metallic luster layer 32, and the DLC layer 33 of the third embodiment, respectively.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

1. A plastic component, comprising:
a polymer base;
a metallic luster layer formed on the polymer base, the metallic luster layer being comprised of a material selected from the group consisting of silicon nitride, silicon carbide, titanium carbide, and a combination thereof;
a diamond-like carbon layer formed on the metallic luster layer, a thickness of the diamond-like carbon layer being in the range from 5 nanometers to 50 nanometers.

2. The plastic component of claim 1, wherein the polymer is selected from the group consisting of polycarbonate, polypropylene, poly (acrylonitrile, butadiene, styrene), poly (methyl methacrylate), and any combination thereof.

3. The plastic component of claim 1, wherein the metallic luster layer consists essentially of one of silicon nitride, silicon carbide, and titanium carbide.

4. The plastic component of claim 1, wherein a thickness of the metallic luster layer is in the range from 50 nanometers to 1000 nanometers.

5. The plastic component of claim 1, wherein the diamond-like carbon layer layer is one of a hydrogenated amorphous diamond-like carbon film and a nitrogenated amorphous diamond-like carbon film.

6. The plastic component of claim 1, wherein the metallic luster layer is in contact with both of the polymer base and the diamond-like carbon layer.

7. The plastic component of claim 1, further comprising an intermediate layer arranged between the polymer base and the metallic luster layer, the intermediate layer being comprised of one of chromium nitride, chromium carbide, and chromium dioxide.

8. The plastic component of claim 1, further comprising an intermediate layer arranged between the polymer base and the metallic luster layer, the intermediate layer consisting of one of chromium nitride, chromium carbide, and chromium dioxide.

9. The plastic component of claim 1, further comprising an electrically conductive layer, the polymer base comprising a first portion and a second portion proximate to the first portion, the metallic luster layer being arranged between the first portion and the diamond-like carbon layer, the electrically conductive layer being arranged between the second portion and the diamond-like carbon layer.

10. The plastic component of claim 9, wherein a thickness of the electrically conductive layer is equal to a thickness of the metallic luster layer.

11. The plastic component of claim 9, wherein the electrically conductive layer consists essentially of one of chromium and aluminum.

12. The plastic component of claim 9, further comprising an intermediate layer arranged between the second portion and the metallic luster layer, the intermediate layer being comprised of one of chromium nitride, chromium carbide, and chromium dioxide.

13. The plastic component of claim 12, wherein a thickness of the electrically conductive layer is equal to a sum of thicknesses of the metallic luster layer and the intermediate layer.

14. The plastic component of claim 13, wherein the first portion has a first outer surface, the second portion has a second outer surface coplanar with the first outer surface, the intermediate layer has a first side surface perpendicular to the second outer surface, the metallic luster layer has a second side surface perpendicular to the second outer surface, the electrically conductive layer has a third side surface perpendicular to the first outer surface, and the third side surface is in contact with both of the first side surface and the second side surface.

15. The plastic component of claim 9, further comprising an intermediate layer arranged between the second portion and the metallic luster layer, the intermediate layer consisting of one of chromium nitride, chromium carbide, and chromium dioxide, a thickness of the electrically conductive layer is equal to a sum of thicknesses of the metallic luster layer and the intermediate layer.

16. A plastic component, comprising:
a polymer base;
a metallic luster layer formed on the polymer base, the metallic luster layer consisting essentially of one of silicon nitride, silicon carbide, and titanium carbide, a thickness of the metallic luster layer being in the range from 50 nm to 1000 nm; and
a diamond-like carbon layer formed on the metallic luster layer, a thickness of the diamond-like carbon layer being in the range from 5 nanometers to 50 nanometers.
